(19) United States
(12) Patent Application Publication
(10) Pub. No.: US 2026/0175294 A1
(43) Pub. Date: Jun. 25, 2026

(54) LASER CLADDING DUAL-PHASE HIGH-ENTROPY ALLOY COATING AND PREPARATION METHOD THEREOF

(71) Applicant: KUNMING UNIVERSITY OF SCIENCE AND TECHNOLOGY, Kunming City (CN)

(72) Inventors: Hongxi LIU, Kunming City (CN); Chen YANG, Kunming City (CN); Yuchong LIU, Kunming City (CN); Yaxia LIU, Kunming City (CN); Xuanhong HAO, Kunming City (CN); Yueyi WANG, Kunming City (CN)

(21) Appl. No.: 19/428,420

(22) Filed: Dec. 22, 2025

(30) Foreign Application Priority Data
Dec. 25, 2024 (CN) 202411924485.3

(51) Int. Cl. B22F 3/105; B22F 9/04; C23C 24/10

(52) U.S. Cl. CPC B22F 3/105; C23C 24/106; B22F 2009/043; B22F 2301/052; B22F 2301/15; B22F 2301/205; B22F 2301/35; B22F 2304/15

(57) ABSTRACT

A laser cladding dual-phase high-entropy alloy coating and a preparation method thereof are provided. The laser cladding dual-phase high-entropy alloy coating includes the following raw materials in atomic percentage: 9 to 16 percent (%) of aluminum (Al), 11 to 17% of chromium (Cr), 11 to 18% of iron (Fe), 13 to 20% of titanium (Ti), 10 to 15% of vanadium (V), and 28 to 33% of nickel (Ni).

### CROSS-REFERENCE TO RELATED APPLICATIONS

This application claims priority to Chinese Patent Application No. 202411924485.3, filed on Dec. 25, 2024, the contents of which are hereby incorporated by reference.

### TECHNICAL FIELD

The present disclosure relates to the technical field of laser surface modification, and in particular to a laser cladding dual-phase high-entropy alloy coating and a preparation method thereof.

### BACKGROUND

High-entropy alloys are a new type of metallic material with a unique design strategy. The alloy composition comprises five or more elements mixed in an equimolar or near-equimolar ratio, with the concentration of each element ranging from 5 percent (%) to 35%. Under the effect of high mixing entropy, the system tends to form a single-phase solid solution. This method breaks through the design philosophy of conventional alloys by expanding the compositional design from the corners to the center of the phase diagram, thereby obtaining excellent comprehensive properties.

Since the concept of high-entropy alloys was proposed, researchers both in China and abroad have conducted extensive systematic research on them. Initially, the phase structure was stabilized by maximizing entropy to achieve excellent and stable properties. However, this method has certain limitations (resulting in a simple-phase microstructure, but also restricting its performance ceiling). Consequently, the strict constraints on composition were relaxed, and attempts were made to adjust alloying elements or compositions to achieve a multi-phase structure, aiming to further enhance the strength and toughness of the alloy and reduce its brittleness. However, the results were not entirely satisfactory. Therefore, there is an urgent need to find a method that may break through the above limitations to obtain an alloy coating material with more excellent properties.

### SUMMARY

An objective of the present disclosure is to provide a laser cladding dual-phase high-entropy alloy coating and a preparation method thereof, so as to solve the problems existing in the aforementioned prior art. The laser cladding dual-phase high-entropy alloy coating of the present disclosure has low brittleness, reduces the crack sensitivity of the laser cladding coating, and exhibits good quality and excellent comprehensive properties.

To achieve the above objective, the present disclosure provides the following schemes:
a first technical scheme of the present disclosure: a laser cladding dual-phase high-entropy alloy coating, including following raw materials in atomic percentage: 9 to 16 percent (%) of aluminum (Al), 11 to 17% of chromium (Cr), 11 to 18% of iron (Fe), 13 to 20% of titanium (Ti), 10 to 15% of vanadium (V), and 28 to 33% of nickel (Ni).

A second technical scheme of the present disclosure: a preparation method for the aforementioned laser cladding dual-phase high-entropy alloy coating, including the following steps:
mixing and ball milling the raw materials to obtain an alloy powder, pre-placing the alloy powder on a surface of a substrate, drying, and then performing laser cladding to obtain the laser cladding dual-phase high-entropy alloy coating.

In an embodiment, the ball milling is performed with a ball-to-powder ratio of 5:1, at a rotation speed of 100 to 140 revolutions per minute (rpm), for a duration of 6 to 10 hours (h).

In an embodiment, the ball milling is performed by alternating forward rotation and reverse rotation, with a pause of 10 to 20 min in between; where a duration of the forward rotation is 20 to 30 min, and a duration of the reverse rotation time is 20 to 30 min.

In an embodiment, a particle size of the raw materials is 15 to 53 micrometers (μm); and the pre-placed thickness of the alloy powder is 0.7 to 1.3 millimeters (mm).

In an embodiment, the drying is performed at a temperature of 60 to 80 degrees Celsius (° C.) for a duration of 6 to 8 h.

In an embodiment, a ratio of the surface area of the substrate to the pre-placed area of the alloy powder is 14 square millimeters (mm²): 4 mm²; and the alloy powder is pre-placed in a middle portion of the substrate.

In an embodiment, conditions for the laser cladding include: an output power of 600 to 850 Watt (W), a laser spot diameter of 3 to 4 mm, a laser scanning speed of 200 to 350 millimeters per minute (mm/min), and an inert atmosphere.

In an embodiment, the substrate includes a titanium alloy substrate (such as a TC4 titanium alloy substrate).

A third technical scheme of the present disclosure: an application of the aforementioned laser cladding dual-phase high-entropy alloy coating in the aerospace field.

The present disclosure has the following technical effects.

The laser cladding dual-phase high-entropy alloy coating of the present disclosure exhibits excellent high-temperature oxidation resistance and wear resistance. Its thermophysical parameters may be matched with those of the TC4 titanium alloy substrate. The cladding layer has no significant defects and forms a metallurgical bond with the substrate. It may prolong the service life of the TC4 titanium alloy, broaden its application scenarios under extreme working conditions, and greatly save the development resources for TC4 titanium alloy.

The present disclosure introduces the Ni element into the laser cladding dual-phase high-entropy alloy coating, utilizes Al/Ni to form an ordered B2 phase having the same structure as body-centered cubic (BCC), thereby regulating the microstructure of the coating and consequently improving the comprehensive properties of the coating (low brittleness, good wear resistance, with a wear rate being only 12.8% of that of the TC4 titanium alloy substrate).

Moreover, the laser cladding dual-phase high-entropy alloy coating of the present disclosure possesses excellent oxidation resistance in air at 800° C., and the oxidation rate of the coating is reduced by 55% compared with that of TC4 titanium alloy substrate.

In the present disclosure, the mixed alloy powder is laid on the surface of the TC4 titanium alloy substrate by a pre-placing method, and a high-energy laser beam is used to irradiate the powder, thereby obtaining a coating which is metallurgically bonded to the substrate, has good forming quality and exhibits good comprehensive properties.

### BRIEF DESCRIPTION OF THE DRAWINGS

To illustrate the technical schemes in the embodiments of the present disclosure or in the prior art more clearly, the following briefly describes the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a cross-sectional morphology diagram of a laser cladding dual-phase high-entropy alloy coating prepared in the Embodiment of the present disclosure.

FIG. 2 is an X-ray diffraction (XRD) pattern of the laser cladding dual-phase high-entropy alloy coating prepared in the Embodiment, the high-entropy alloy coating prepared in Comparative Example 1, and the high-entropy alloy coatings prepared in Comparative Example 1 and Comparative Example 2 of the present disclosure.

FIG. 3 is a scanning electron microscope (SEM) and element distribution diagram of the laser cladding dual-phase high-entropy alloy coating prepared in the Embodiment of the present disclosure.

FIG. 4 is a wear rate diagram of a TC4 titanium alloy substrate (Ti6Al4V) used in the present disclosure, the laser cladding dual-phase high-entropy alloy coating prepared in the Embodiment, the high-entropy alloy coating prepared in Comparative Example 1, and the high-entropy alloy coatings prepared in Comparative Example 2 and Comparative Example 3 of the present disclosure.

FIG. 5 is an oxidation weight gain curve diagram of the TC4 titanium alloy substrate (Ti6Al4V) used in the present disclosure, the laser cladding dual-phase high-entropy alloy coating prepared in the Embodiment, the high-entropy alloy coating prepared in Comparative Example 1, and the high-entropy alloy coatings prepared in Comparative Example 2 and Comparative Example 3 of the present disclosure.

### DETAILED DESCRIPTION OF THE EMBODIMENTS

Various exemplary embodiments of the present disclosure are described in detail below. This detailed description is not to be construed as limiting the disclosure, but rather as providing a more detailed description of certain aspects, characteristics, and embodiments of the present disclosure.

It needs be understood that the terms used herein are merely for the purpose of describing particular embodiments and are not intended to limit the disclosure. In addition, for numerical ranges in the present disclosure, each intermediate value between the upper and lower limits of the range is also specifically disclosed. Each smaller range between any stated value or intermediate value within a stated range and any other stated or intermediate value within the range is also encompassed within the disclosure. The upper and lower limits of these smaller ranges may independently be included or excluded in the range.

Unless otherwise defined, all technical and scientific terms used herein have the same meaning as commonly understood by one of ordinary skill in the art to which this disclosure belongs. Although only preferred methods and materials are described herein, any methods and materials similar or equivalent to those described herein may also be used in the practice or testing of the present disclosure. All publications mentioned in this specification are incorporated by reference to disclose and describe the methods and/or materials related to the publications. In case of conflict with any incorporated publication, the content of this specification shall prevail.

Various modifications and variations of the specific embodiments described herein may be made without departing from the scope or spirit of the disclosure, which will be apparent to those skilled in the art. Other embodiments derived from the description of the present disclosure will be obvious to those skilled in the art. The description and examples of the present disclosure are exemplary only.

Regarding the terms “comprising”, “including”, “having”, “containing”, etc. used herein, they are open-ended terms, meaning including but not limited to.

### EMBODIMENT

A preparation method for a laser cladding dual-phase high-entropy alloy coating, including the following steps:
(1) the laser cladding dual-phase high-entropy alloy coating includes the following raw materials in atomic percentage: 14 percent (%) of aluminum (Al), 14% of chromium (Cr), 14% of iron (Fe), 14% of titanium (Ti), 14% of vanadium (V), and 30% of nickel (Ni).
(2) According to the atomic percentage, Al powder, Cr powder, Fe powder, Ti powder, V powder, and Ni powder are weighed using an electronic balance with an accuracy of +0.1 milligram (mg) (all powders are commercial spherical powders with a particle size of 15 to 53 micrometers (μm)).
(3) The raw material powders are mixed according to the ratio and placed in a ball milling jar. Ball milling is performed under controlled conditions: a ball-to-powder ratio of 5:1, stainless steel balls with a diameter of 3 millimeters (mm) as grinding media, and a rotation speed of 120 revolutions per minute (rpm). The ball milling is performed by alternating forward rotation and reverse rotation, with a duration of the forward rotation of 20 minutes (min), a duration of the reverse rotation of 20 min, and a pause of 15 min in between constituting one ball milling cycle. The mixing continues for 10 hours (h) to obtain the alloy powder.
(4) A TC4 titanium alloy is cut into a plate of 40 mm×14 mm×4 mm using wire electrical discharge machining. The oxide layer and oil stains on the surface of the TC4 titanium alloy are then removed by coarse grinding with 400-grit metallographic sandpaper. The plate is placed in alcohol for ultrasonic cleaning for 10 min and then dried to obtain the TC4 titanium alloy substrate.
(5) The alloy powder is pre-placed on the surface of the TC4 titanium alloy substrate. The dimensions of the pre-placed powder are 40 mm×4 mm×1 mm, and it is pre-placed in the middle portion of the substrate surface, thereby obtaining a pre-fabricated sample.
(6) The pre-fabricated sample is placed in a vacuum dryer and dried at 80 degrees Celsius (° C.) for 6 h to obtain a dried sample.
(7) The dried sample is placed in a fiber laser irradiation device. After releasing argon gas for 5 min, argon gas is continuously supplied at a rate of 15 liters per minute (L·min⁻¹). The pre-placed layer is irradiated with the fiber laser under controlled conditions: a laser output power of 800 Watt (W), a laser spot diameter of 3 mm, and a laser scanning speed of 300 millimeters per minute (mm/min). After irradiation, the argon gas supply is maintained for 5 min until the sample is completely cooled, thereby obtaining a TC4 titanium alloy having the laser cladding dual-phase high-entropy alloy coating (named Al₁₄Cr₁₄Fe₁₄Ti₁₄V₁₄Ni₃₀ based on atomic percentage).

### Comparative Example 1

The procedure is the same as in the Embodiment, except that the alloy coating (AlCrFeTiV) includes the following raw materials in mass percentage: 12 weight percent (wt. %) of Al, 22 wt. % of Cr, 24 wt. % of Fe, 21 wt. % of Ti, and 21 wt. % of V (the atomic percentage being 1:1:1:1:1).

### Comparative Example 2

The procedure is the same as in Embodiment 1, except that the laser cladding dual-phase high-entropy alloy coating includes the following raw materials in atomic percentage: 16% of Al, 16% of Cr, 16% of Fe, 16% of Ti, 16% of V, and 20% of Ni.

### Comparative Example 3

The procedure is the same as in Embodiment 1, except that the laser cladding dual-phase high-entropy alloy coating includes the following raw materials in atomic percentage: 18% of Al, 18% of Cr, 18% of Fe, 18% of Ti, 18% of V, and 10% of Ni.

### Effect Example 1

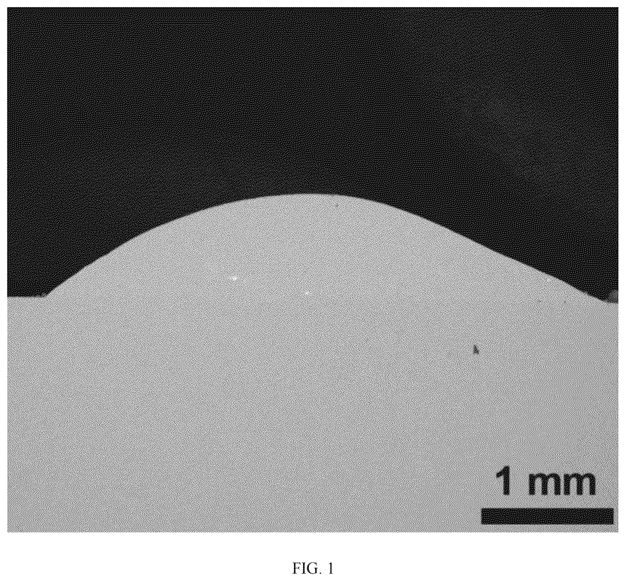

The cross-sectional morphology diagram of the laser cladding dual-phase high-entropy alloy coating prepared in the Embodiment is shown in FIG. 1.

It may be seen from FIG. 1 that there are no obvious cracks in the coating, and a metallurgical bond is formed with the titanium alloy substrate. Furthermore, based on the bonding line, it may be seen that the dilution rate of the substrate is not high, which may effectively ensure the comprehensive properties of the coating.

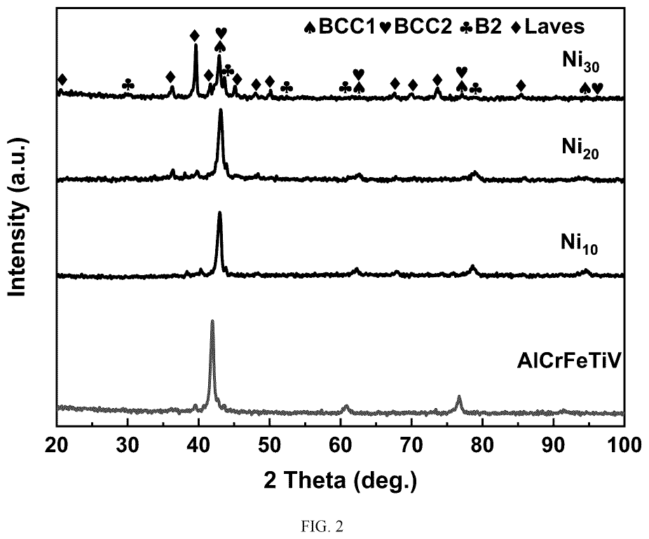

The X-ray diffraction (XRD) patterns of the laser cladding dual-phase high-entropy alloy coating (Ni₃₀) prepared in the Embodiment, the high-entropy alloy coating (AlCrFeTiV) prepared in Comparative Example 1, the high-entropy alloy coating (Ni₂₀) prepared in Comparative Example 2, and the high-entropy alloy coating (Ni₁₀) prepared in Comparative Example 3 are shown in FIG. 2.

It may be seen from FIG. 2 that with the introduction of the Ni element, diffraction peaks of the Laves phase appear in the coating. When the atomic percentage of the Ni element is 30%, a small diffraction peak appears around 30 degrees, which is determined to be the ordered B2 phase.

### Effect Example 2

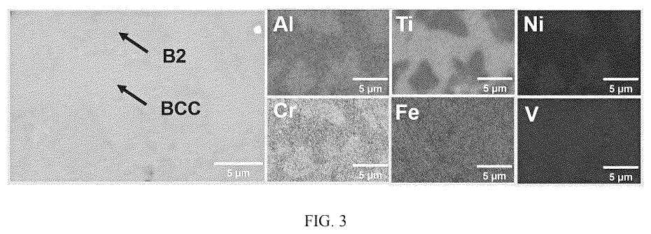

The scanning electron microscope (SEM) and element distribution diagrams of the laser cladding dual-phase high-entropy alloy coating prepared in the Embodiment are shown in FIG. 3.

It may be seen from FIG. 3 that there are obviously two types of microstructure morphologies with different contrasts in the coating. The Energy Dispersive X-ray Spectroscopy (EDS) mapping results indicate that the B2 phase is mainly enriched with Al and Ni elements.

### Effect Example 3

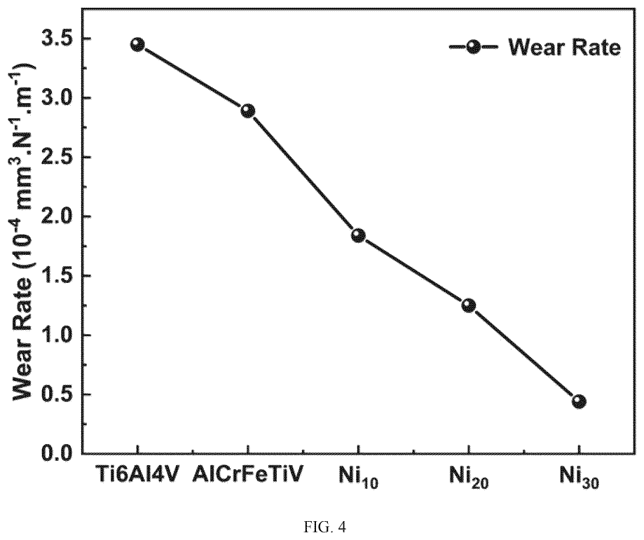

A multifunctional wear tester (UMT-2) is used to evaluate the wear resistance of the coatings. A silicon nitride (Si₃N₄) ceramic ball with a diameter of 3 mm is selected as the counterpart, and a reciprocating wear method is employed for the wear test. Wear tests are conducted on the coating (the TC4 titanium alloy substrate (Ti6Al4V) in FIG. 4), the coating prepared in the Embodiment (Ni₃₀ in FIG. 4), the coating prepared in Comparative Example 1 (AlCrFeTiV in FIG. 4), the coating prepared in Comparative Example 2 (Ni₂₀ in FIG. 4), or the coating prepared in Comparative Example 3 (Ni₁₀ in FIG. 4) under a load of 20 Newton (N), with a wear scar length of 2 mm, an oscillation frequency of 1 Hertz (Hz), and a wear duration of 30 min. The wear rate results are obtained based on the corresponding wear volume, applied load, and total sliding distance, as shown in FIG. 4.

It may be seen from FIG. 4 that the wear rate of the TC4 titanium alloy substrate is 3.45×10⁻⁴ cubic millimeter per newton per meter (mm³·N⁻¹·m⁻¹), and the wear rate of the AlCrFeTiV high-entropy alloy coating is 2.89×10⁻⁴ mm³·N⁻¹·m⁻¹. With the introduction of the Ni element, the wear rate of the coatings decreases significantly. The wear rate of the laser cladding dual-phase high-entropy alloy coating prepared in the Embodiment is only 0.44×10⁻⁴ mm³·N⁻¹·m⁻¹, which substantially improves the wear resistance of the coating.

### Effect Example 4

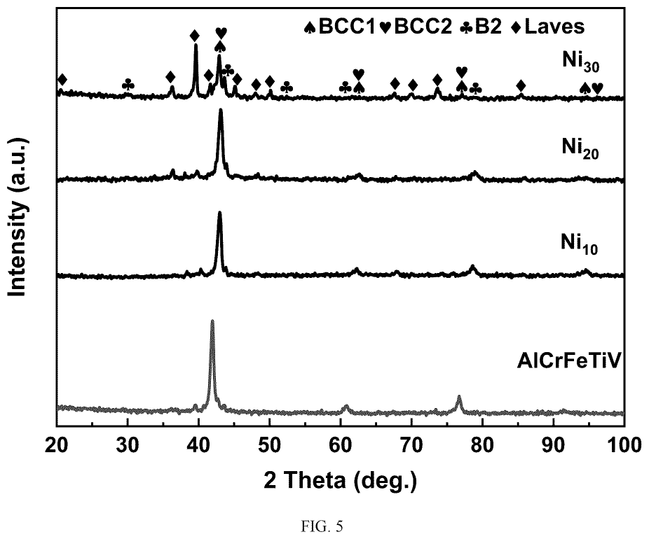

The TC4 titanium alloy substrate (i.e., Ti6Al4V), the laser cladding dual-phase high-entropy alloy coating prepared in the Embodiment (i.e., Ni₃₀), the high-entropy alloy coating prepared in Comparative Example 1 (i.e., AlCrFeTiV), the high-entropy alloy coating prepared in Comparative Example 2 (i.e., Ni₂₀), and the high-entropy alloy coating prepared in Comparative Example 3 (i.e., Ni₁₀) are simultaneously placed in a box furnace. Oxidation is conducted in air at 800° C. for 0.5, 5, 15, 30, and 50 h. The samples are then cooled to room temperature, and the weight difference of the samples is recorded using an electronic scale with an accuracy of +0.1 mg. The results are shown in FIG. 5.

It may be seen from FIG. 5 that the oxidation weight gain of the laser cladding dual-phase high-entropy alloy coating prepared in the Embodiment of the present disclosure is significantly reduced under the condition of 800° C. in air, and its oxidation rate is only 55% of that of the TC4 titanium alloy substrate. Moreover, when the atomic percentage of the Ni element is 30%, its high-temperature oxidation resistance is optimal.

Through research, it is found that the high-entropy alloy coating prepared in Comparative Example 1 is a single-phase BCC high-entropy alloy coating. This single-phase body-centered cubic (BCC) high-entropy alloy coating exhibits significantly increased cracks; during the grinding and polishing process, the coating has high brittleness, and small particles fall off. Furthermore, its high-temperature oxidation resistance and wear resistance are significantly decreased. In the Embodiment, due to the introduction of the Ni element, the precipitation of the Al/Ni ordered B2 phase, which has the same structure as BCC, is promoted. This not only effectively regulates the forming quality of the coating but also further improves the comprehensive properties of the coating.

The embodiments described above are merely illustrative of the optional embodiments of the present disclosure and are not intended to limit the scope of the disclosure. Various modifications and improvements to the technical schemes of the present disclosure made by those skilled in the art without departing from the design spirit of the present disclosure shall fall within the protection scope defined by the claims of the present disclosure.

What is claimed is:

1. A laser cladding dual-phase high-entropy alloy coating, comprising following raw materials in atomic percentage: 9 to 16 percent (%) of aluminum (Al), 11 to 17% of chromium (Cr), 11 to 18% of iron (Fe), 13 to 20% of titanium (Ti), 10 to 15% of vanadium (V), and 28 to 33% of nickel (Ni).

2. A preparation method for the laser cladding dual-phase high-entropy alloy coating according to claim 1, comprising following steps:
mixing and ball milling the raw materials to obtain an alloy powder, pre-placing the alloy powder on a surface of a substrate, drying, and then performing laser cladding to obtain the laser cladding dual-phase high-entropy alloy coating.

3. The preparation method according to claim 2, wherein the ball milling is performed with a ball-to-powder ratio of 5:1, at a rotation speed of 100 to 140 revolutions per minute (rpm), and for a duration of 6 to 10 hours (h).

4. The preparation method according to claim 3, wherein the ball milling is performed by alternating forward rotation and reverse rotation with a pause of 10 to 20 minutes (min) in between; wherein a duration of the forward rotation is 20 to 30 min, and a duration of the reverse rotation is 20 to 30 min.

5. The preparation method according to claim 2, wherein a particle size of the raw materials is 15 to 53 micrometers (μm); and a pre-placed thickness of the alloy powder is 0.7 to 1.3 millimeters (mm).

6. The preparation method according to claim 2, wherein conditions for the laser cladding comprise: an output power of 600 to 850 Watt (W), a laser spot diameter of 3 to 4 mm, a laser scanning speed of 200 to 350 millimeters per minute (mm/min), and an inert atmosphere.

7. The preparation method according to claim 2, wherein the substrate comprises a titanium alloy substrate.
